(19) United States
(12) Patent Application Publication
(10) Pub. No.: US 2013/0174196 A1
(43) Pub. Date: Jul. 4, 2013

(54) METHOD AND SYSTEM FOR DETERMINING IDENTITY/PRESENCE OF A MOBILE DEVICE USER FOR CONTROL AND INTERACTION IN CONTENT DISTRIBUTION

(71) Applicant: Gregory Charles Herlein, San Francisco, CA (US)

(72) Inventor: Gregory Charles Herlein, San Francisco, CA (US)

(73) Assignee: THOMSON LICENSING, Issy de Moulineaux (FR)

(21) Appl. No.: 13/824,053

(22) PCT Filed: Sep. 17, 2010
(86) PCT No.: PCT/US10/02529

§ 371 Date: Mar. 15, 2013

(51) Int. Cl. H04N 21/458

(52) U.S. Cl. CPC H04N 21/458
USPC 725/35

(57) ABSTRACT

A method and system for using a mobile device identifier, such as an Electronic Serial Number (ESN) or a Mobile Equipment Identifier (MEID), of a mobile device for communication in a content distribution environment includes detecting the ESN of a mobile device when in or within a predetermined range of the content distribution environment. Once the mobile device identifier has been detected, demographic and user identification information of the mobile device is obtained via one or more databases and selected media content is then delivered to one or more selected display devices, such as a display device nearest to the mobile device.

### FIELD OF THE INVENTION

The present invention generally relates to communication methods within content distribution environments and systems and, more particularly, to a method, apparatus and system for using mobile device identifiers, such as Electronic Serial Numbers (ESN) and Mobile Equipment Identifiers (MEID), for control and interaction within a content distribution playback environment.

### BACKGROUND OF THE INVENTION

Information and content distribution systems are used to provide information and content to a plurality of end systems. For example, in the advertising realm, providing in-store retail media content is becoming the most popular advertising medium in use today, with broadcast distribution being its primary means of content presentation. That is, in recent years retailers and the managers of public spaces have brought in video display systems for advertising use. In such systems, content is distributed by a server and received at receivers such as a respective set-top-box for each display or group of displays and associated speakers. Retailers use the displays and speakers to present their current offerings or sale information, while the public spaces sell time on the video displays and speakers to advertisers either national or local, knowing that large numbers of consumers will see the presentation.

However, as will be appreciated by those providing the advertising (i.e., either the content distribution environment or the product/service provider), the most effective advertising is preferably targeted to the particular viewer, for example, such that a presentation for a specific viewer is selected in such a way that the information about the offered product is a good match for the viewer(s) near the screen.

In order to implement this type of targeted deployment of advertising media, it is critical to uniquely identify the people near the screen or display device in the content distribution environment. One such unique means to specifically identify a potential or existing customer is to detect a mobile device identifier, such as the ESN or MEID, of their phone or mobile device and use that as a unique index or key to look up demographic or identity information about the person who owns the phone. Once this information is known, the advertising media can be selected and displayed accordingly.

### SUMMARY OF THE INVENTION

Embodiments of the present invention address the deficiencies of the prior art by providing a method, apparatus and system for using a mobile device identifier, such as the ESN or MEID, of a mobile electronic device for control and interaction within a content distribution playback environment.

According to an embodiment, the method for communication in a content distribution environment includes detecting a mobile device identifier, such as the ESN or MEID, of a mobile device present within the content distribution environment, identifying demographic information related to a registered owner of the mobile device using the detected mobile device identifier information, and displaying media at display devices within the content distribution environment using the identified demographic information.

In another embodiment, the system for communication in a content distribution environment, includes at least one mobile device identifier detector configured to passively listen to broadcast signals from mobile devices within the content distribution environment and detect the mobile device identifier corresponding to each mobile device, and a server in signal communication with the at least one mobile device identifier detector. The server being configured to identify demographic information related to a registered owner of the mobile device using the detected mobile device identifier, and display media at a display device located within the content distribution environment using the identified demographic information.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system and a mobile communications system in which an embodiment of the present invention can be applied;

FIG. 2 depicts a high level block diagram of an in-store advertising network for providing in-store advertising in accordance with an embodiment of the present invention;

FIG. 3 depicts a high level block diagram of the content distribution system and mobile communication system according to an embodiment of the present invention;

FIG. 4 depicts a high level block diagram of the mobile device identifier detector in accordance with an embodiment of the present invention; and

FIG. 5 depicts a flow diagram of a method for using the mobile device identifier for control and interaction in a content distribution environment in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for using the mobile device identifier of a cell phone or other mobile device, for control and interaction within a content distribution (playback) environment. Although the present invention will be described primarily within the context of a retail advertising network environment using a detected Electronic Serial Number (ESN) for a mobile device, the specific embodiments of the present invention should not be treated as limiting the scope of the invention. It will be appreciated by those skilled in the art and informed by the teachings of the present invention that the concepts of the present invention can be advantageously applied in substantially any content distribution environment using other communications means such as Bluetooth and using other mobile device identifiers such as a Mobile Equipment Identifier (MEID).

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudo code, and the like represent various processes which may be substantially represented in computer readable media and so executed by a computer or processor, whether or not such computer or processor is explicitly shown.

The various embodiments of the present invention include using ESN information. For example, shoppers often have a cell phone or other mobile device having a unique ESN. In accordance with embodiments of the present invention, an advantageous way to interact with the shopper is provided by detecting their presence in a media distribution environment (e.g., a retail location) using their mobile device ESN and coupling (i.e., linking) that user identification with other demographic information about the mobile device owner. A playback system (e.g., system 100) can then play an ad based on that information and the user's detected location within the retail location and/or on their uniquely identified mobile device.

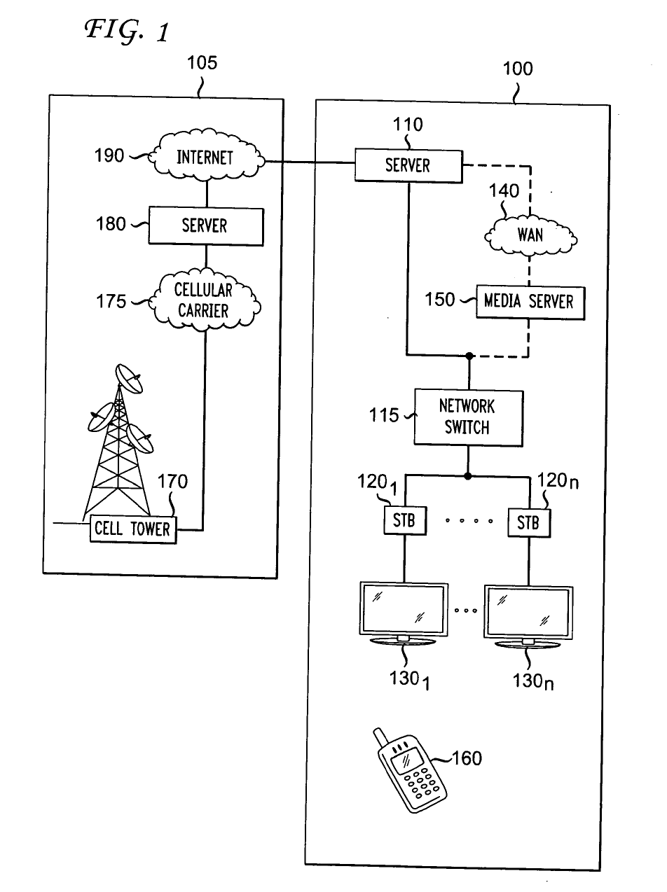

FIG. 1 depicts a high level block diagram of a content distribution system and a mobile communications system 105 in which an embodiment of the present invention can be applied. The content distribution system 100 of FIG. 1 illustratively comprises at least one server 110, a switch 115 (illustratively a network switch), a plurality of receiving devices such as tuning/decoding means (illustratively set-top boxes (STBs)) 120₁-120ₙ, and a respective display 130₁-130ₙ for each of the set-top boxes 120₁-120ₙ. The content distribution system 100 of FIG. 1 further includes an optional wide-area-network (WAN) 140, an optional media server 150 and a mobile communications device 160 (illustratively a mobile phone).

Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as text, audio, video and/or audio/video content.

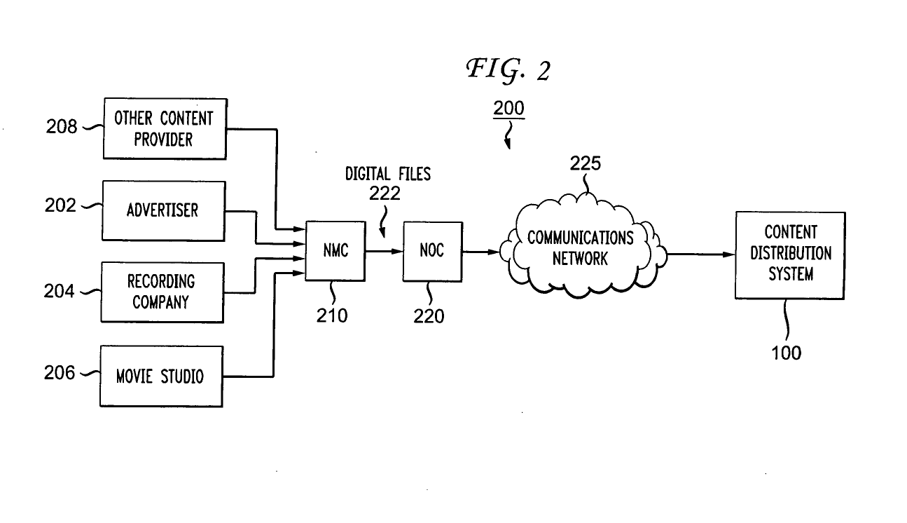

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG2, MPEG4/MPEG4 Part 10/AVC-H.264, VC-1, Windows Media, etc.), although the present system is not limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “infomercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

Referring back to FIG. 1, the server 110 of the content distribution system 100 is capable of receiving content (e.g., distribution packs) and, accordingly, distribute them in-store to the various receivers such as the set-top boxes 120 and displays 130. That is, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of text, audio, video and/or audio/video to be communicated to the various receivers throughout the store. The streams can be individual channels of text, modulated audio, video and/or audio/video onto a radio frequency distribution or transmitted as data flows within a unicast or multicast internet protocol (IP) network. These streams can originate from one or more servers under the same logical set of control software.

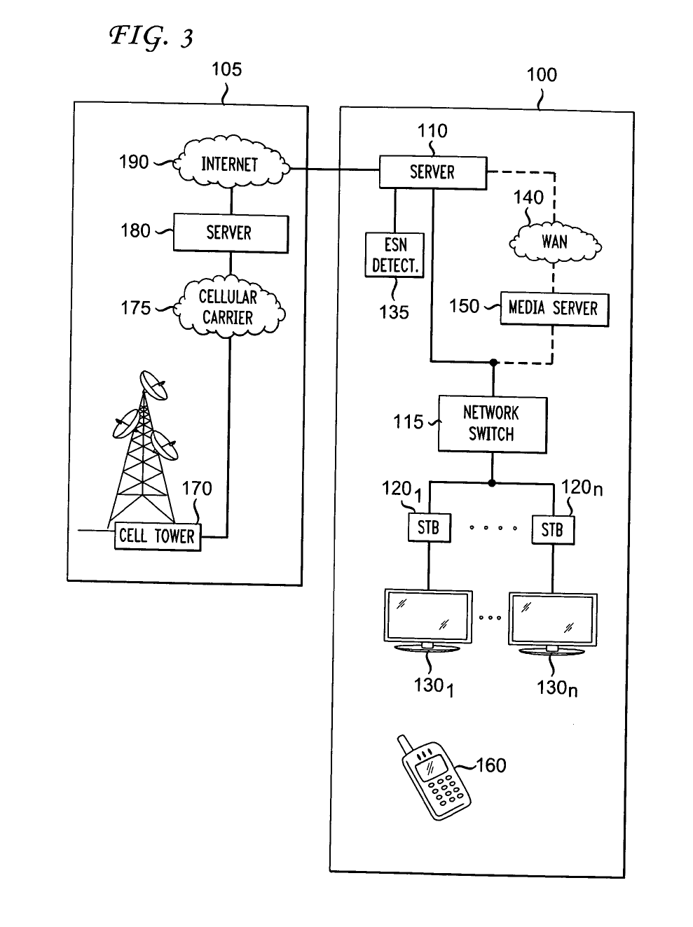

Referring back to FIG. 1, the mobile communication system 105 of FIG. 1 illustratively comprises a cell tower 170, a cellular carrier 175, a server 180 (e.g., an SMS server) and an Internet 190. In the embodiment shown in FIG. 3, a mobile device identifier detector 135 (illustratively an Electronic Serial Number (ESN) detector) is added to the content distribution system 100. The ESN detector 135 is connected to the server 110 and is configured to detect the presence of mobile device in the content distribution environment 100. As will be explained in further detail below, once the ESN is detected, the server 110 can communicate with internal databases or external databases, such as, for example, the internet 190 and one or more servers 180 (or databases) to obtain demographic information about the user of the mobile device registered to the detected ESN. The server 110 and/or media server 150 can then “react” to the obtained demographic information by choosing the most appropriate advertising to play for this user at a display device closest to them based on their detected location within the content distribution environment 100.

In one embodiment of the content distribution system 100 of FIG. 1 in which the server 110, as described above, creates various different streams (e.g., content channels) of text, audio, video and/or audio/video to be communicated to the various receivers throughout the store, and is the central control point for content distribution and control and also delivers local over-rides to the stores and is the central log collection and health status collection point for a set of stores, the server 110 responds to a detected ESN of the mobile communications device 160 with an appropriate response, which will be described in greater detail below. That is, the server 110 communicates an appropriate response to the mobile communications device 160 by causing the display of the response on a display 130 in the proximity of the detected mobile communications device.

For example, in one embodiment of the present invention, a display 130 in proximity of a user whose mobile device identifier has been passively detected by the detector 135 can be identified. That is, in one embodiment of the present invention, each display or group of displays can be assigned a unique number to display to a user for use by the user whose presence has been detected through their mobile device identifier, such as an ESN or MEID.

In an alternate embodiment of the content distribution system 100 of FIG. 1 which includes a local WAN 140 and a media server 150, the media server 150 typically delivers local over-rides to the stores and is the central log collection and health status collection point for a set of stores. The media server 150 is also typically the location where the configuration settings for stores are cached. In such an embodiment, the server 110 processes the received demographic information corresponding to the detected ESN and communicates the demographic information over the WAN 140 to the media server 150. The communicated information directs the media server 150 to take an appropriate action in response to the received information.

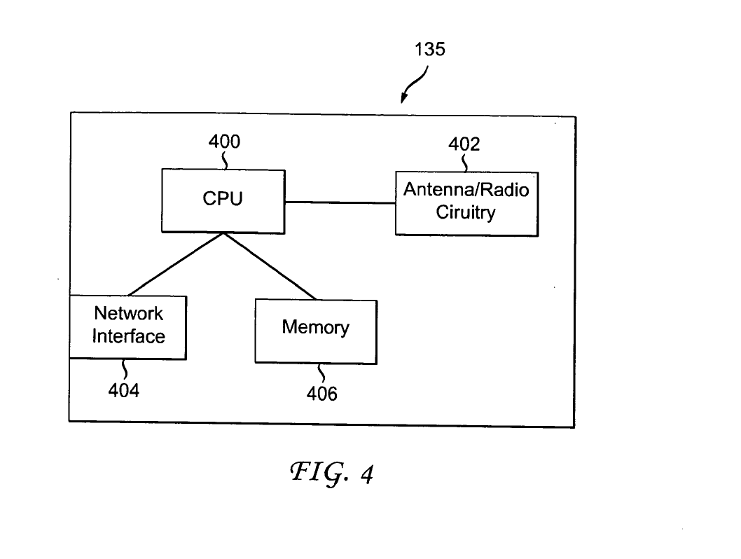

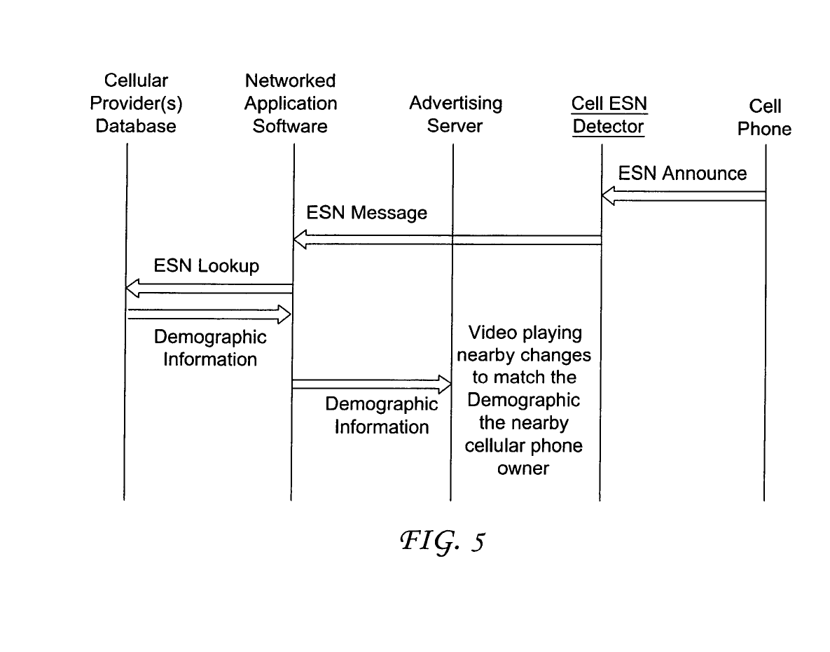

Referring to FIG. 4, there is shown an exemplary implementation of a mobile device identifier detector, such and the ESN detector 135 of FIG. 1 according to an embodiment of the invention. The mobile device identifier detector 135 can include a central processing unit (CPU) 400 in signal communication with the antenna/radio circuitry 402. The antenna/radio circuitry 402 is configured to be compatible with modern cellular/mobile devices and will passively listen to regular broadband signals from mobile devices that identify themselves to their carrier (e.g., cellular carrier 175). The detector 135 includes a Network interface 404 that enables the same to be connected to, for example, the server 110 or directly to the Internet or other WAN. The detector 135 can also include a memory 406 for storing data relating to detected mobile identifiers and possible utilize those detected identifiers at a later time when the user returns to the content distribution environment.

In accordance with an embodiment of the present invention, the ESN detector 135 of FIG. 1 passively listens to the regular broadband signals from mobile devices that the mobile devices typically use to identify themselves and their location to their respective carriers. In an alternative embodiment, the ESN detector 135 can listen to the probe packets used by mobile devices to detect available networks for connection (e.g., access points to available networks). The user's mobile device identifier can be obtained from these probe packets. In one embodiment of the present invention, once a mobile device identifier is detected, the detector 135 will exchange this information with the networked application software running on the server 110.

In accordance with various embodiments of the present invention, several detectors 135 can have predetermined ranges and can be distributed throughout a content distribution environment 100 such that the detector providing mobile device identifier information, such as ESN information, to the server 110 can be used to locate the mobile device user within the content distribution environment, and thereby identify the appropriate display device or devices 130 to send the appropriate advertising information.

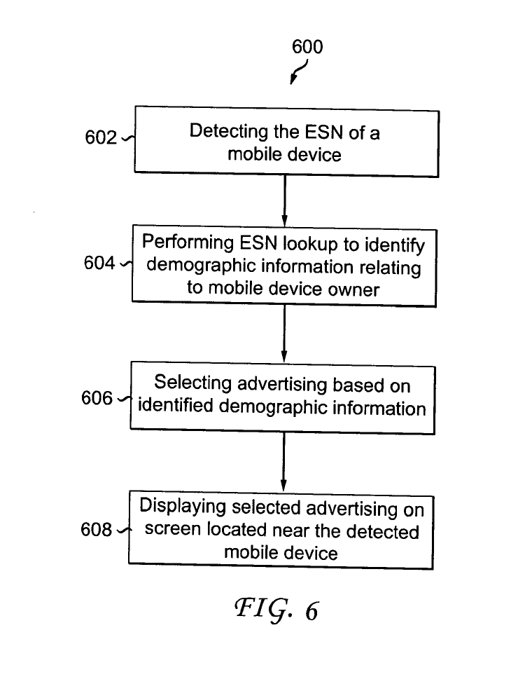

For example, FIG. 5 depicts an example sequence diagram for detecting and using mobile communication device identifier information for targeting the distribution of advertising media in a content distribution environment in accordance with an embodiment of the present invention. As depicted in FIG. 5, a cell phone broadcasts signals (illustratively in the embodiment of FIG. 5, ESN signals) designed to identify itself with its carrier. The ESN detector of FIG. 5 listens for and detects these broadcast signals and obtains the user's ESN. The ESN detector then sends an ESN Message to the networked application software (e.g., in the embodiment of FIG. 5, resident in server 110 within the content distribution environment 100 of FIG. 1). The software instructs the server 110 to perform and ESN lookup using one or more mobile device provider databases, and to obtain demographic information relating to the detected ESN information. In the embodiment of FIG. 5, once obtained, the demographic information is sent to the network server 110 or an advertising server (e.g., media server 150), where it is used to select the most appropriate advertising to play for the demographic of cell phone users near the display screens, thus specifically targeting the advertising distribution to particular locations within the content distribution environment 100.

Those of skill in the art will appreciate that the demographic information lookup based on the identified ESN can come from various sources. For example, the ESN/demographic information lookup could be obtained: 1) from business partnerships; 2) by purchase from outside providers; and/or 3) by internal databases storing previously obtained demographic information from a user's prior ESN identification within the particular content distribution environment.

FIG. 6 depicts a high level flow diagram of a method 600 for targeting media distribution using detected mobile device identifiers, such as Electronic Serial Numbers (ESN) and Mobile Equipment Identifiers (MEID), from a mobile communication device. Initially, the mobile device identifier of a mobile device is detected (602). This is performed using an mobile device identifier detector configured to passively listen to regular broadcasted signals from mobile communication devices that identify themselves to their respective carriers. Once the user's mobile device identifier has been detected, a mobile device identifier lookup (604) is performed to obtain demographic information relating to the owner of the mobile communication device identified by the detected mobile device identifier information. Using the obtained owner demographic information, advertising material can be selected (606) by, for example, an advertising server either within the content distribution environment or connected thereto through one or more networks. Once the selection of content to be displayed to the identified mobile device owner has been made, the system displays (608) selected content on a selected display screen(s), for example in one embodiment, a display screen(s) that is in close proximity to the detected mobile communication device.

Having described various embodiments for a method and system for using mobile device identifiers, such as Electronic Serial Numbers (ESN) and Mobile Equipment Identifiers (MEID), for control and interaction within a content distribution environment (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for communication in a content distribution environment, comprising:
detecting a mobile device identifier of a mobile device present within the content distribution environment;
identifying demographic information related to a user of the mobile device using the detected mobile device identifier; and
selecting at least one display device within the content distribution environment on which to display selected content, using the identified demographic information.

2. The method of claim 1, wherein said mobile device identifier comprises at least one of an Electronic Serial Number (ESN) and a Mobile Equipment Identifier (MEID) of a mobile device.

3. The method of claim 1, wherein said detecting comprises listening to broadcasted signals transmitted by the mobile device to identify the mobile device with its service carrier.

4. The method of claim 1, wherein said identifying comprises performing a look-up of mobile device user demographic information corresponding to the detected mobile device identifier.

5. The method of claim 4, wherein said performing a lookup comprises accessing a database outside the content distribution environment.

6. The method of claim 1, wherein said selecting comprises identifying display devices closest to the mobile device corresponding to the detected mobile device identifier and display selected content on at least a display device closest to the mobile device.

7. The method of claim 1, wherein said detecting comprises listening to probe packets transmitted by the mobile device to identify other available networks for connection to the mobile device.

8. The method of claim 1, wherein said user is registered owner of the mobile device.

9. A system for communication in a content distribution environment, comprising:
at least one mobile device identifier detector configured to passively listen to broadcast signals from mobile devices within the content distribution environment and detect the mobile device identifier corresponding to the mobile devices; and
a server in signal communication with the at least one mobile device identifier detector and being configured to:
identify demographic information related to a user of the mobile device using the detected mobile device identifier; and
select at least one display device within the content distribution environment on which to display selected content, using the identified demographic information.

10. The system of claim 9, further comprising:
at least one media player in signal communication with the server and configured to play the content to be displayed; and
at least one display device in signal communication with the at least one media player.

11. The system of claim 9, wherein said at least one mobile device identifier detector comprises:
radio circuitry compatible with mobile devices and configured to listen to the broadcast signals;
a processing unit in signal communication with the radio circuitry; and
a connection interface for connecting the mobile device identifier detector to a network.

12. The system of claim 9, wherein said server determines which of said at least one display device is closest to the detected mobile device and activates at least one media player for causing the displaying of selected content on said closest at least one display device.

13. The system of claim 12, wherein said determination of which display is closest to the detected mobile device is based on which of said at least one ESN detectors provided the ESN information relating to the mobile device.

14. The system of claim 9, wherein said at least one mobile device identifier detector detects the identifier of the mobile device by listening to probe packets transmitted by the mobile device in order to identify available networks.

15. The system of claim 9, wherein said mobile device identifier comprises at least one of an Electronic Serial Number (ESN) and a Mobile Equipment Identifier (MEID) of a mobile device.
